(19) United States
(12) Patent Application Publication
(10) Pub. No.: US 2008/0034437 A1
(43) Pub. Date: Feb. 7, 2008

(54) Controlling access to electronic content

(75) Inventor: Patrick E. Patterson, Arlington, VA (US)

Correspondence Address: MCGUIREWOODS, LLP, 1750 TYSONS BLVD, SUITE 1800, MCLEAN, VA, 22102, US

(73) Assignee: DRM Technologies, LLC, Tucson, AZ (US)

(21) Appl. No.: 11/889,611

(22) Filed: Aug. 15, 2007

Related U.S. Application Data
(63) Continuation of application No. 11/400,394, filed on Apr. 10, 2006.
Application No. 11/400,394 is a continuation of application No. 10/110,718, filed on Jun. 17, 2003, now abandoned.
(60) Provisional application No. 60/159,327, filed on Oct. 14, 1999.

(51) Int. Cl. H04L 9/32

(52) U.S. Cl. 726/26

(57) ABSTRACT

A computer-implemented method of controlling access to electronic content includes receiving electronic content and producing a file that includes the electronic content and instructions for collecting and transmitting payment information. The method further includes receiving a reply to the transmitted message and selectively providing access to the electronic content based on the reply.

### REFERENCE TO RELATED APPLICATIONS

This application relates to U.S. patent application Ser. No. 09/199,150, entitled “Tracking Electronic Content” which is incorporated by reference in its entirety.

### TECHNICAL FIELD

This invention relates to controlling access to electronic content.

### BACKGROUND

Networks such as the Internet offer organizations a powerful tool for distributing information. For example, many merchant Web-sites offer on-line catalogs that use multimedia presentations to sell goods and services. Unfortunately, as the convenience of Internet shopping and research attracts greater numbers of users, a corresponding increase in Internet traffic has lengthened download times. As users sometimes pay for network access by the hour, lengthy download times can be costly as well as time consuming.

While some users suffer from delays, some Web-site owners can have difficulty attracting visitors to their site. For example, a typical search engine such as Yahoo!™ can generate a lengthy list of Web-sites for almost any user search request. Few users bother to explore each listed site.

### SUMMARY

In general, in one aspect, the invention features a computer-implemented method of controlling access to electronic content includes receiving electronic content and producing a file that includes the electronic content and instructions for collecting and transmitting payment information. The method further includes receiving a reply to the transmitted message and selectively providing access to the electronic content based on the reply. Advantages can include one or more of the following. The envelope creation instructions enable virtually any content developer connected to the Internet to publish and receive payment for electronic content. Additionally, as the envelope instructions remain with the envelope throughout its life, the envelope author continues to receive payment from users accessing the envelope contents regardless of how the users obtained the envelope.

The envelope provides a simple to use and intuitive user interface that guides recipients through the process of paying for content. The presentation of the electronic content in an envelope can be tailored by the envelope creator, for example, by designating content that will be presented automatically when the content is opened. This enables envelope creators to craft the envelopes for different purposes.

The storage of creator-defined data in the server database permits collection of different information for each envelope such as envelope-specific questionnaires. The collected information can be used to target distribution of subsequent envelopes to potentially interested recipients. By distributing the envelope via e-mail, recipients need not experience the sometimes lengthy delays associated with downloading web-pages from the Internet.

Other advantages of the invention will become apparent in view of the following description, including the figures, and the claims.

### DESCRIPTION OF THE DRAWINGS

FIG. 1 is a diagram an electronic content distribution system.

FIG. 2 is a flowchart of a process for creating an envelope.

FIGS. 3-8 are screenshots of a user interface for creating envelopes.

FIGS. 9-13 are screenshots of another user interface for creating envelopes.

FIGS. 14-16 are screenshots of a user interface provided by an envelope.

FIG. 17 is a flowchart of envelope instructions.

FIGS. 18-19 are flow diagrams illustrating establishment of secure communication between a client and a server.

FIG. 20 is a diagram of a server database that tracks envelopes.

FIG. 21 is a flowchart of server access request processing instructions.

FIG. 22 is a flow diagram of a snake that “flattens” a collection of linked pages.

### DETAILED DESCRIPTION

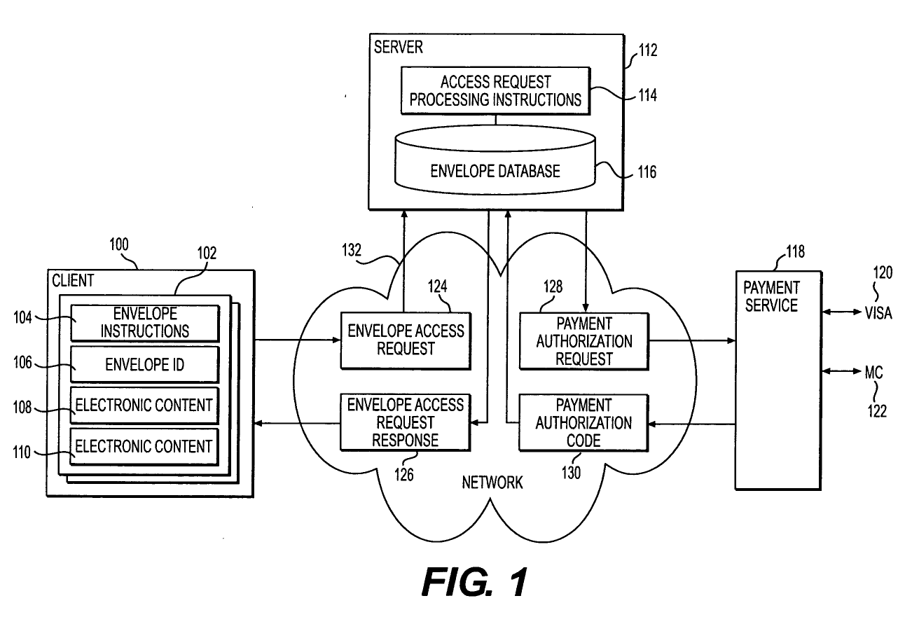

Referring to FIG. 1, an envelope file 102 (envelope) stores electronic content 108, 110 such as audio, graphics, text, video, and/or computer program instructions. The envelope 102 also stores envelope instructions 104 that can extract and present the stored electronic content 108, 110 to a user requesting access to the content 108, 110. The envelope instructions 104 may form part of a system that enables an envelope creator to collect payment from each user attempting to access the content 108, 110.

As shown in FIG. 1, a user at a client 100 has received an envelope 102, for example, via e-mail or by downloading the file from a networked computer (e.g., an Internet web-server). When the user attempts to access the electronic content 108, 110 included in the envelope 102, the envelope instructions 104 transmit an access request 124 to a server 112 via a network 132 (e.g., the Internet). The access request 124 can include an envelope identifier 106 that uniquely identifies the envelop 106 to the server 112; payment information such as a credit card number, payment amount, and expiration date; and/or demographic information such as a user's address, phone number, and e-mail address.

The server 112 can store information included in the access request 124 in an envelope database 116, for example, for subsequent marketing analysis. The server 112 can also send a payment authorization request 128 to a payment service 118 such as Maverick™. The payment service 118 acts as a clearinghouse for different credit card bureaus such as Visa 120 or MasterCard 122. The credit card bureaus can process payment authorization requests by deducting the payment amount from a first account (e.g., a user submitting the access request 124) and by crediting a second account (e.g., an account of the envelope creator). After receiving a payment authorization code 130 from the payment service 118, the server 112 can transmit an access request response 126 back to the client 100. The envelope instructions 104 executing on the client 100 can permit or deny access to the electronic content based on the received access request response 126.

Other embodiments eliminate system elements shown in FIG. 1. For example, in some embodiments the envelope instructions interact directly with the payment service 118 or credit bureau 120, 122 instead of communicating with these entities via the server 112.

The envelope instructions 104 ensure that each user has authorized access to the electronic content 108, 110. Thus, the envelope 102 enables a content distributor to make an envelope 102 freely available with lessened concern over electronic content piracy. For example, an envelope distributor can post an envelope 102 for downloading on an Internet web-page or at an FTP (File Transfer Protocol) site. Additionally, a distributor can e-mail envelopes 102 to recipients who have previously requested access to envelopes in the past. The ability to target envelopes 102 to interested consumers makes the envelope 102 a valuable marketing tool. Additionally, e-mailing the envelope to selected recipients eliminates the time a user would have to wait for the electronic content to download from a web-site.

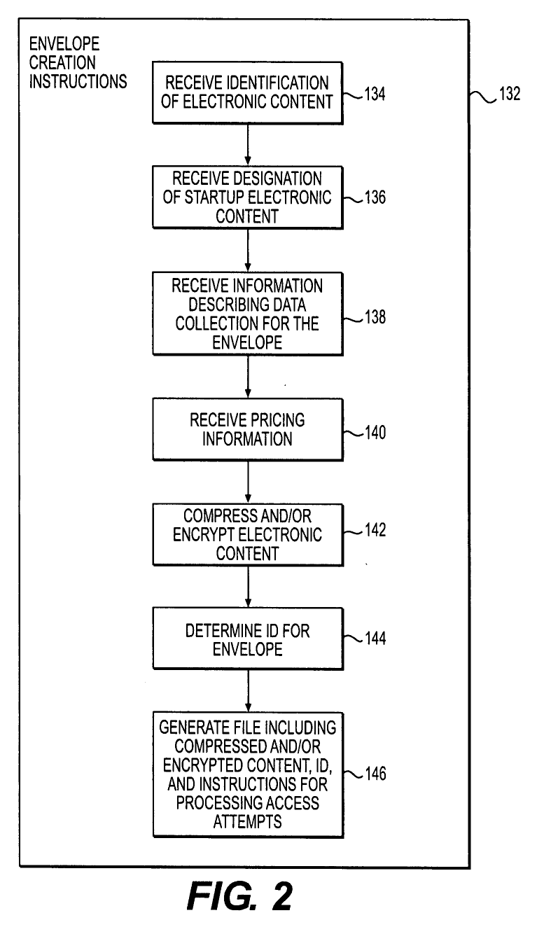

Referring to FIG. 2, envelope creation instructions 132 enable quick construction of an envelope for distribution. After identifying 134 electronic content for inclusion in the envelope (e.g., by providing file names or URLs (Universal Resource Locators)), a user can configure the envelope to have different characteristics.

For example, a user can designate 136 electronic content for automatic opening after the server grants access to envelope contents. By selecting electronic content for automatic opening, the envelope creator can control the initial presentation of envelope contents rather than leaving users to explore content 108, 110 included in the envelope 102 on their own. In one embodiment, the user can designate electronic content for automatic opening by naming the file “Startup” (e.g., startup.html). Launching the electronic content can cause an the operating system to open the file using an application corresponding to the file extension (e.g., “.HTML” corresponds to Microsoft™ Explorer™ and “.DOC” corresponds to Microsoft™ Word97™).

The creation software 132 also enables a user to define data collected 138 by the envelope instructions 104 prior to requesting access. For example, a user can use HTML instructions to define a data collection form having text, graphics, and data fields. The envelope instructions 104 interpret the HTML and present the form to a user requesting access. By defining fields a user can collect a wide variety of information such as responses to a questionnaire, demographic information, etc.. The collected information is transmitted to the server 112 for storage and analysis. The use of HTML to specify a data collection form enables creators to take advantage of their existing HTML coding skills. Alternatively, the user can specify data collection instructions that collect information from the client 100 Windows™ Registry™ instead of interactive collection from a user.

The envelope creator may specify 140 a price for the electronic content 108, 110. The price can be included in each access request sent by the envelope instructions 104 to the server 112. Alternatively, an envelope creator can establish the price by calling a server representative or by e-mailing the price to a server daemon. Similar techniques may be used to supply the server with an account number that is to be credited when an envelope recipient pays for access to an envelope.

The envelope creator may also specify 142 password protection, encryption (e.g., Blowfish encryption), and/or compression of the electronic content. These options can enhance the security of the electronic content 108, 110 as it travels over a public network, reduce the size of the envelope, and prevent users from access the electronic content without requesting access from the server 112.

As described above, each envelope 102 stores 144 an envelope identifier 106 (e.g., a character string) that uniquely identifies the envelope 102 to the server 112. The identifier 106 can be determined in a number of different ways. For example, the envelope creation program 132 can append a system clock time to a computer's IP (Internet Protocol) address. Alternatively, the creation software 132 can request a unique envelope identifier from the server 112 during the envelope creation process.

After configuration, the creation software 132 builds the envelope 102 from the identified electronic content 108, 110, the envelope identifier 106, and the envelope instructions 104. The creation software 132 arranges envelope 102 components such that execution of the envelope file (e.g., “C: run envelope.exe”) causes execution of the envelope instructions.

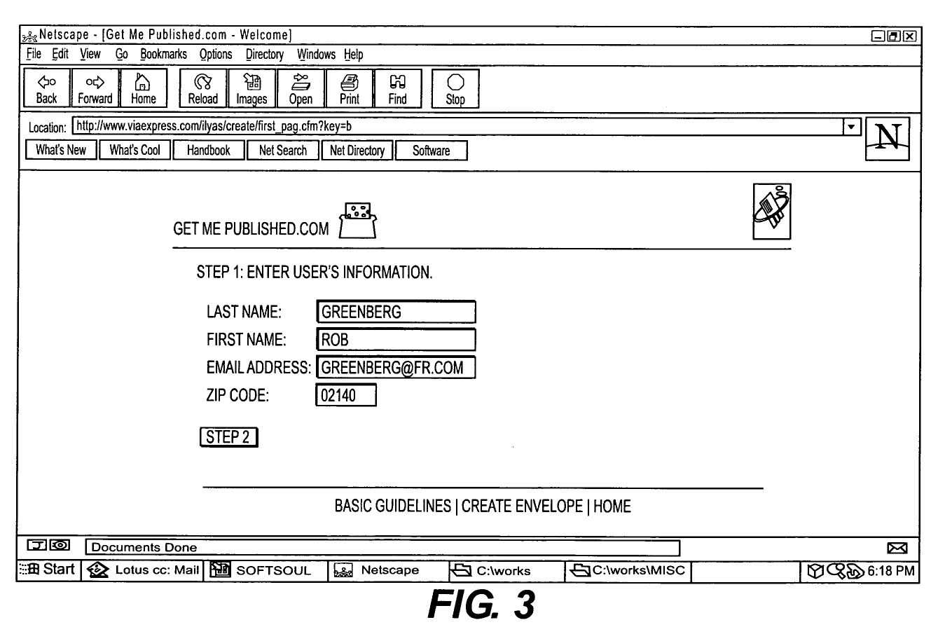

The envelope creation instructions 132 can employ a variety of different user interfaces and can use a number of different architectures. For example, referring to FIGS. 3 to 8, the envelope creation software 132 may reside on a web server. A user visiting the web server can build an envelope by filling in a series of forms that collect envelope configuration information from a creator.

As shown in FIG. 3, a user visiting a web server that offers envelope creation can enter an e-mail address. The envelope creation instructions 132 can e-mail the completed envelope to the specified address.

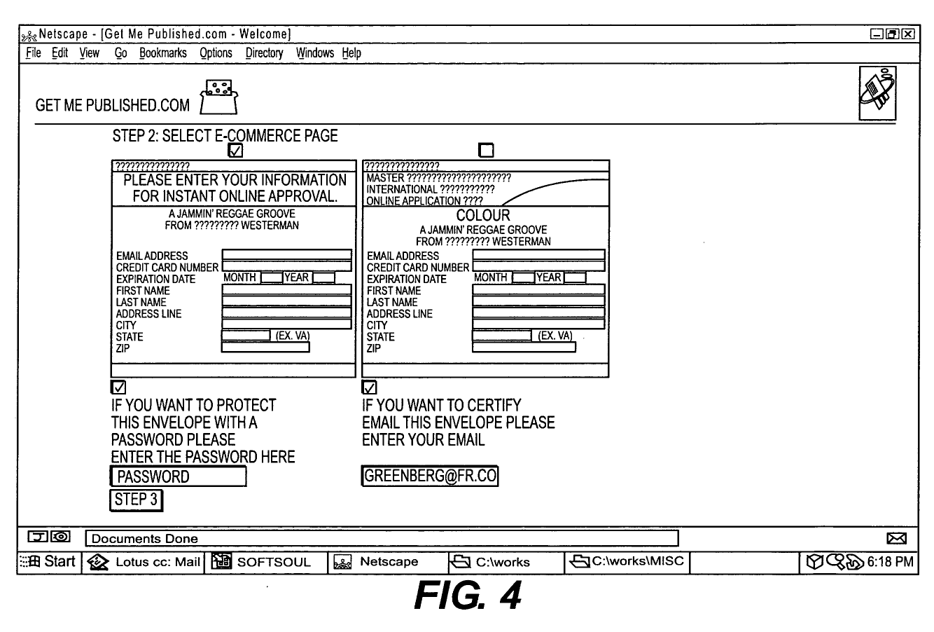

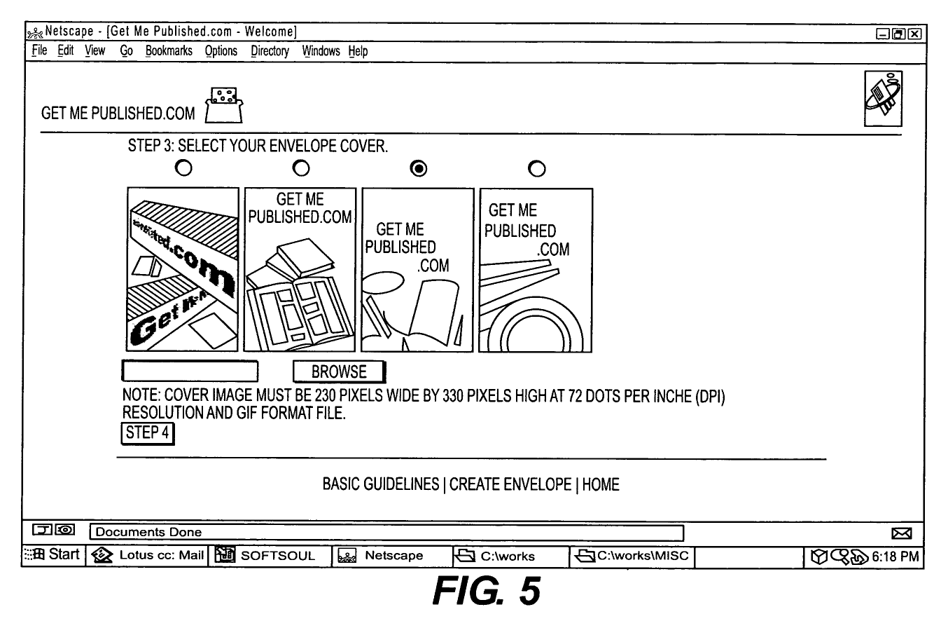

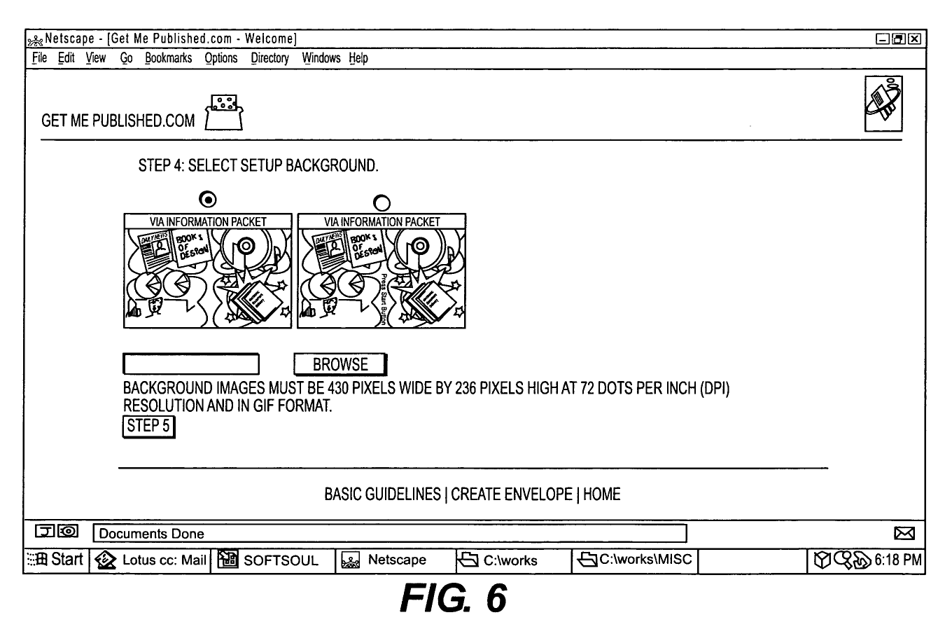

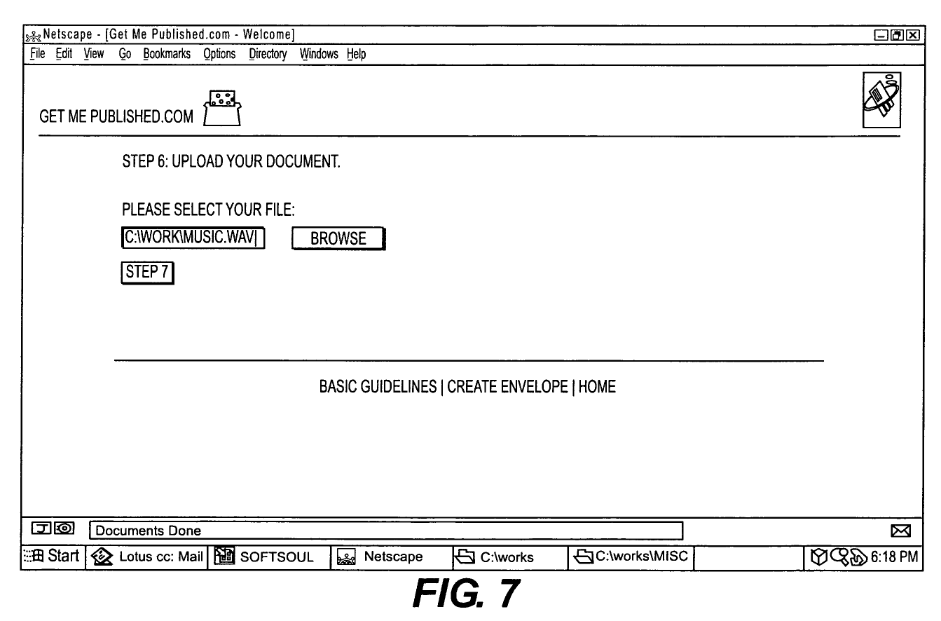

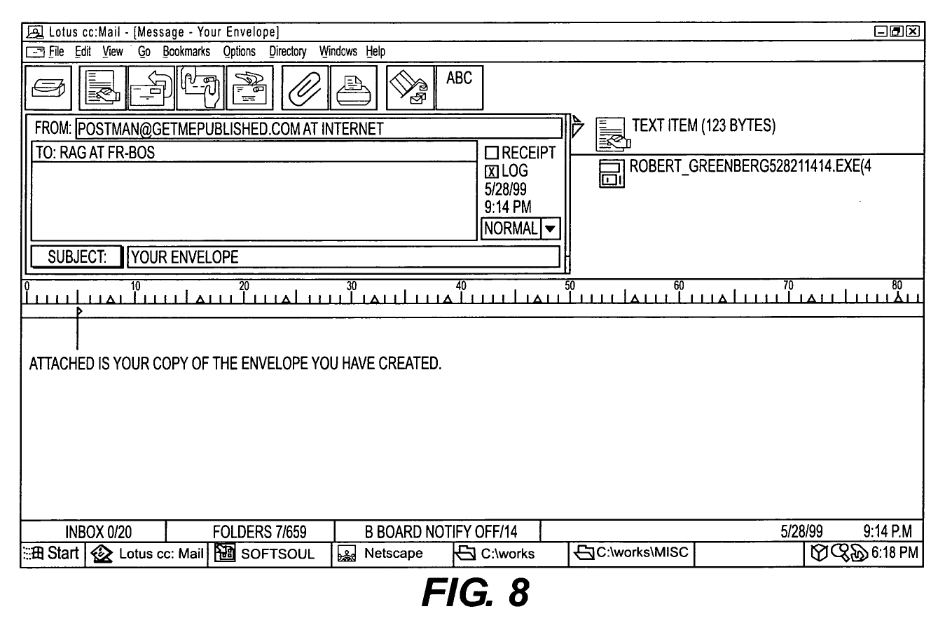

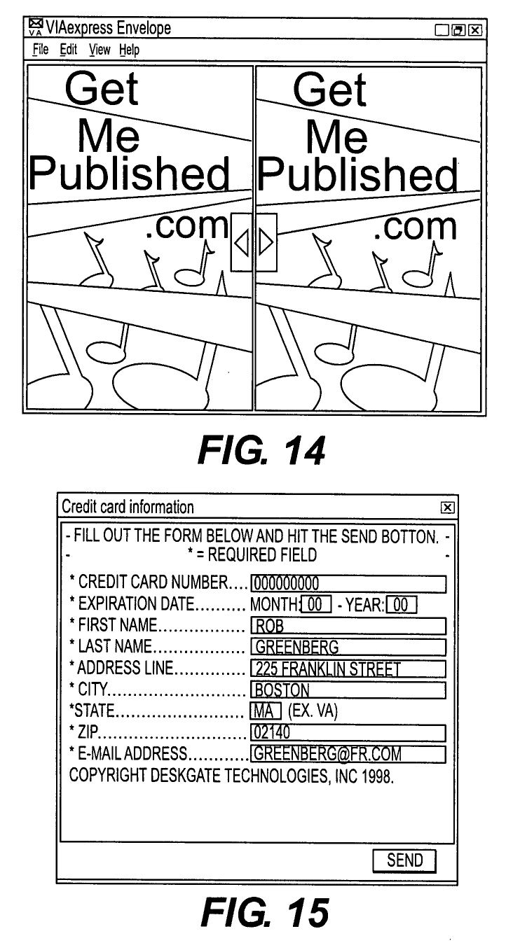

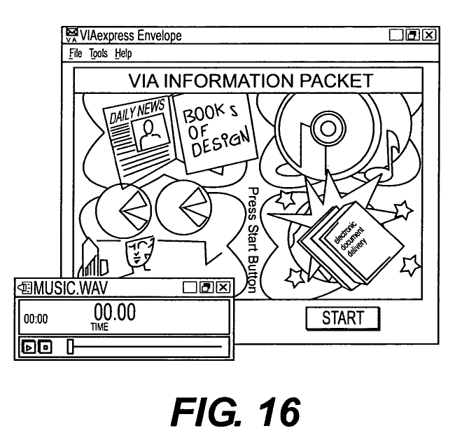

As shown in FIG. 4, the user can select from different default data collection forms instead of defining their own. The user can also specify password protection and/or certification (see co-pending application 09/199,150, entitled “Tracking Electronic Content”). As shown in FIGS. 5 and 6, the user can select or designate graphics for an envelope cover (see FIG. 14) and graphics for display when a user opens the envelope (see FIG. 16). As shown in FIG. 7, the user can specify one or more files for inclusion as electronic content in the envelope. As shown in FIG. 8, the envelope creator receives the completed envelope via e-mail. In other embodiments, the completed envelope is stored at a web-site for subsequent downloading at the creator's convenience or can be stored on a removable computer-readable medium, such as a CD-ROM, and then be distributed to recipients, e.g., by conventional postal service.

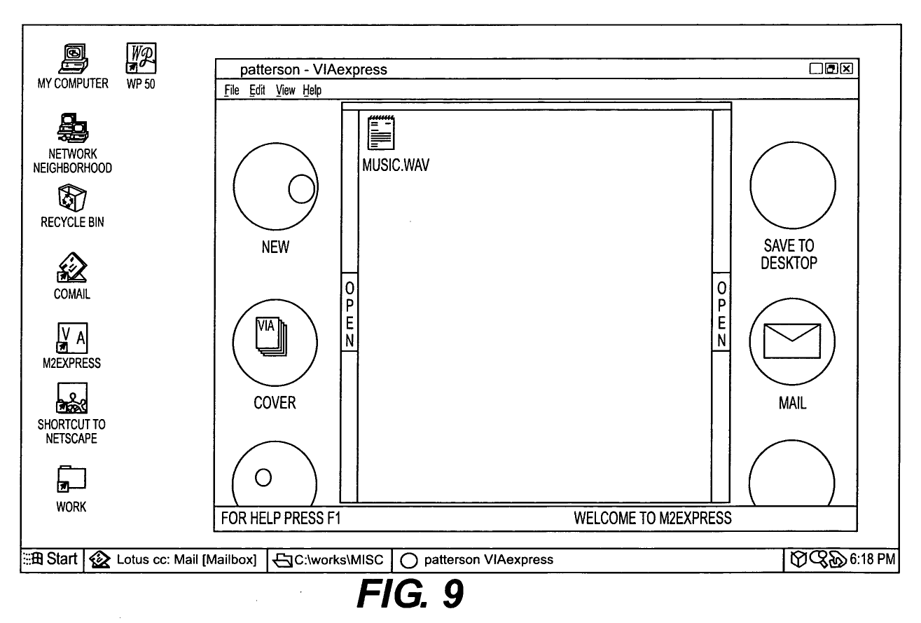

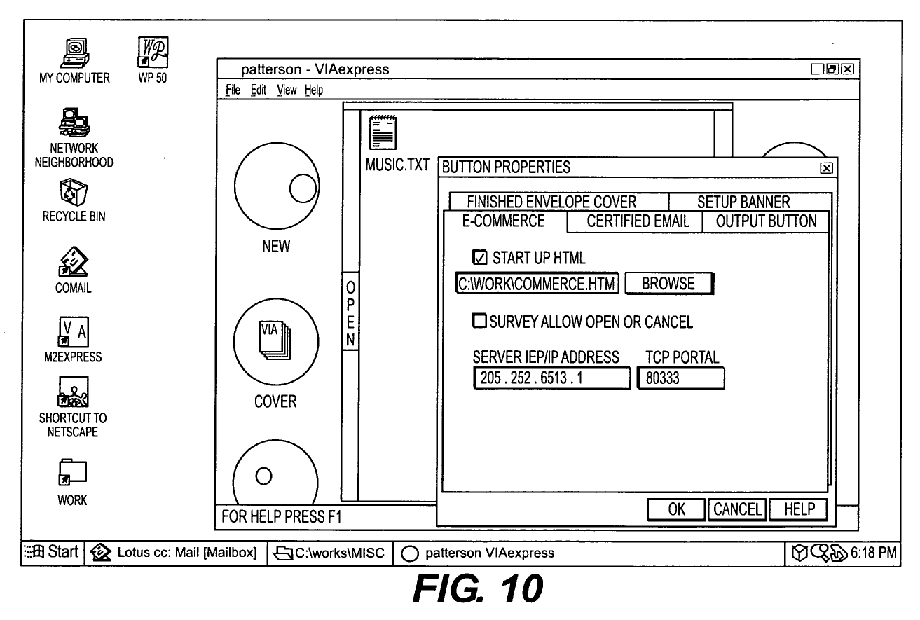

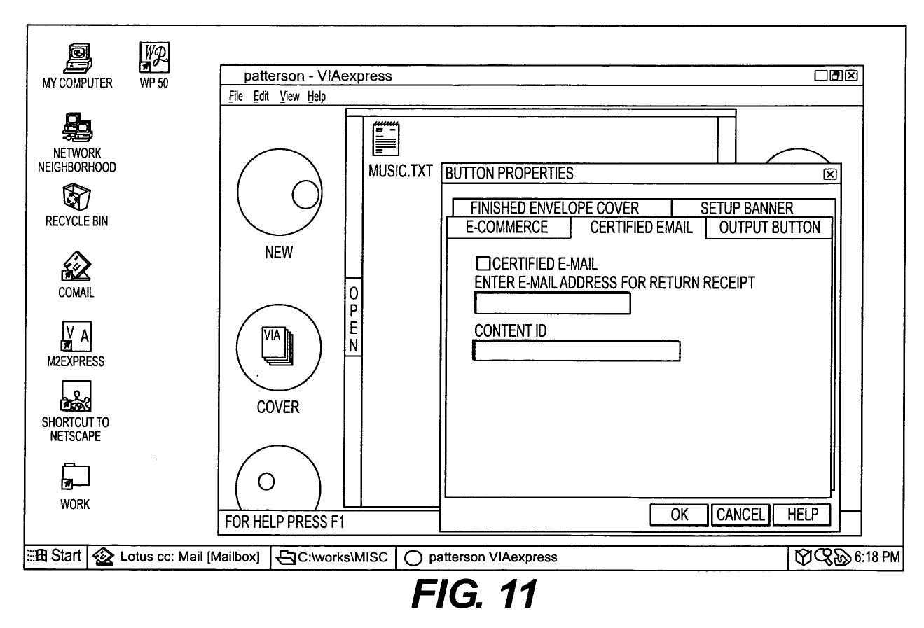

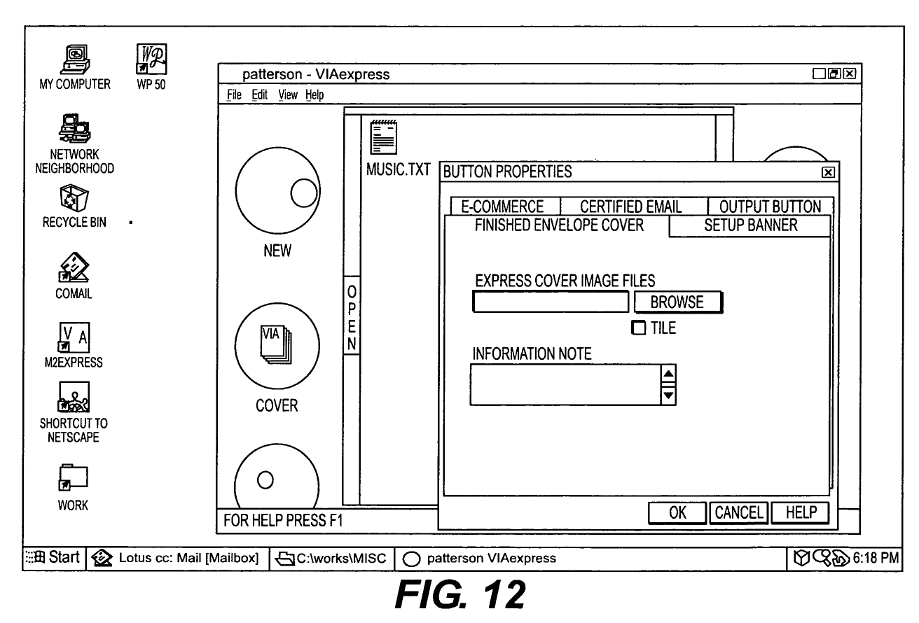

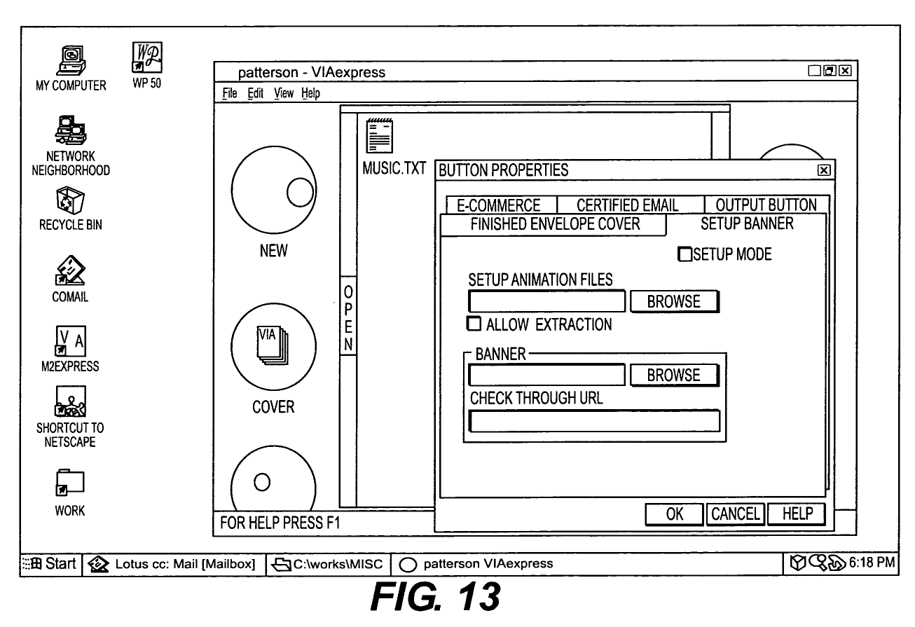

Referring to FIGS. 9-13, in a different embodiment, the envelope creation software 132 is a stand-alone application. As shown in FIG. 9, the application enables a user to create an envelope by dragging-and-dropping files into the envelope. The user can interact with a series of dialogs that enable a user to specify a data collection form (FIG. 10); to specify whether the envelope uses certification (FIG. 11); to specify the cover image (FIG. 12); and to specify whether to automatically open electronic content upon access (FIG. 13).

Both of the embodiments above can use the same envelope creation instructions. For example, the envelope creation software can be coded as a component (e.g., a COM component) that provides a set of public methods such as envelope.Build, envelope.AddContent, and envelope.SetPassword. This component can be included in a stand-alone application or called by a program at the web-server.

Referring to FIGS. 14-16, the finished envelope provides recipients with an intuitive user interface when executed. The interface uses a vault theme that users can quickly operate without guidance. As shown in FIG. 14, the interface depicts vault doors with handle GUI buttons. The vault doors include the envelope cover graphics selected or created by the user. Selecting (e.g., clicking using mouse-buttons) the handle GUI buttons causes the access envelope instructions to present the user-defined data collection form shown in FIG. 15. The data collection form dialog includes a “SEND” button that causes the instructions to transmit the access request to the server 112 including the collected data. After receiving the server's 112 grant of access to the electronic content, the envelope instructions can present the electronic content and/or store the electronic content on the user's machine. For example, the envelope instructions 104 can automatically play a .WAV sound file included in the envelope. If access is denied, the envelope typically will no present, decrypt, and/or decompress the stored electronic content.

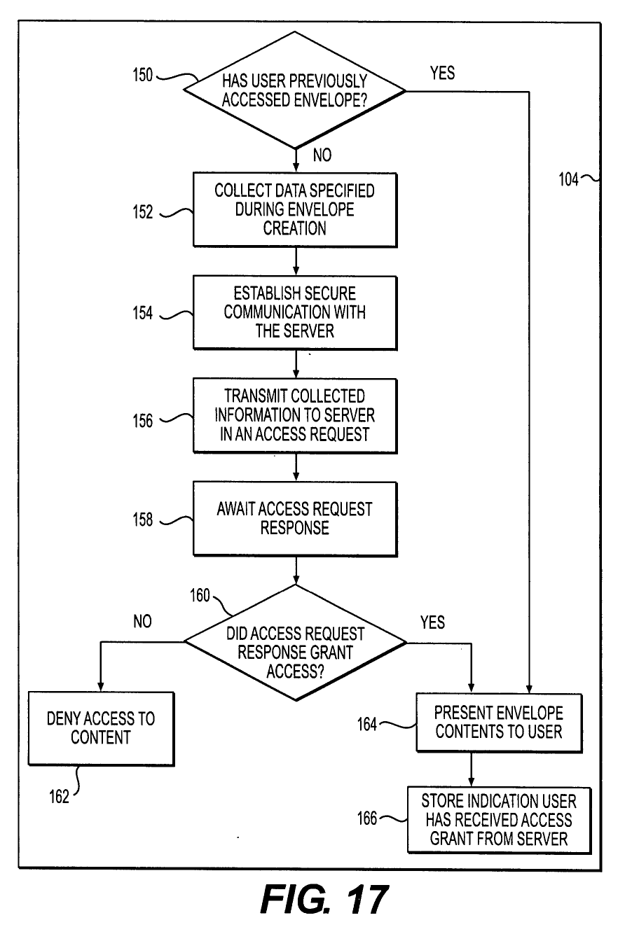

Referring to FIG. 17, upon execution of the envelope file 102, the envelope instructions 104 determine 150 if the user has previously received a message from the server granting access to the electronic content 108, 110. For example, the envelope instructions may store the envelope ID in the Windows™ Registry after receiving an access grant. By checking the Registry for the envelope ID, the instructions can avoid asking the same user to pay for electronic content more than once. If the user has previously received an access grant, the envelope instructions 104 can present 164 the electronic content by decompressing and/or decrypting the content. The instructions 104 may store the decompressed and/or decrypted content in a temporary directory (e.g., “C:/temp/”). The instructions 104 may also automatically launch any designated startup content.

If the user has not previously received an access grant, the envelope instructions 104 collect 152 data specified during envelope creation and include the data in an access request 156 to the server 112. Prior to transmitting the request, the instructions 104 establish secure communication with the server 112. For example, the instructions 104 may initiate a secure socket layer (SSL) connection between the client 100 and server 112.

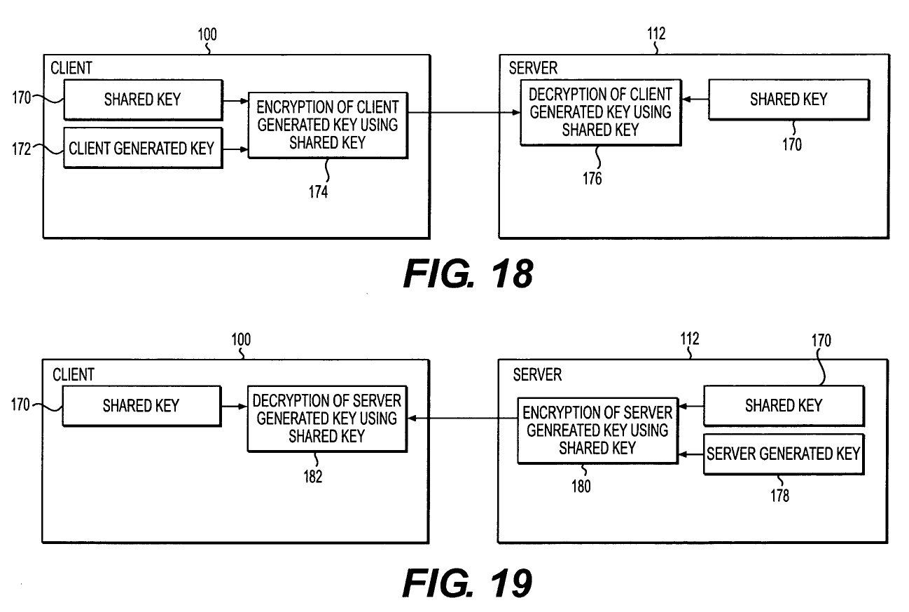

Referring to FIG. 18, in another embodiment, the client 100 and server 112 establish secure communication through the use of a key shared 170 both by the client 100 and by server 112. In this embodiment, the client 100 encrypts 174 (e.g., using Blowfish encryption) a client generated key 172 (e.g., a random number) using the shared key 170. The client 100 transmits the encrypted client generated key to the server 112 for decryption 176 using the shared key. The client generated key, now known by both the client 100 and server 112 is used as an encryption key for subsequent communication from the client 100 to the server 112. Referring to FIG. 19, a similar process is used to generate a server 112 encryption key for communication from the server 112 to the client 100.

Regardless of which encryption technique is used, establishing secure communication helps prevent network eavesdroppers from determining credit card numbers and other access request information traveling between the client 100 and server 112.

Referring again to FIG. 17, after establishment of secure communication 154, the client transmits 156 the collected data to the server 112. The envelope instructions 104 use a variety of techniques to evade network firewalls. For example, the data and the names of the collected data fields can be included in the header of an HTTP message. For example, an HTTP header may include the string “Name&Robert;Phone&956-5908;CC#&11112222333;Exp&01/00” defining the field names and values for name, phone, and credit card information. In other embodiments, the string is included after a JPEG (Joint Pictures Experts Group) start code to fool a firewall into believing a picture is being transmitted.

The instructions 104 attempt to transmit the access request via a communication port conventionally associated with browser communication (e.g., port 80). If such an attempt fails, the instructions 104 attempt to transmit the collected data via an SMTP (Simple Mail Transfer Protocol) port (e.g., port 25). The instructions may also examine the client 112 Windows™ Registry to determine whether the client connects to the network via a proxy.

After transmitting 156 the data, the instructions 104 await 158 an access request response from the server 112. If an access request response indicates the server 112 has granted access, the instructions 104 decompress and/or decrypt 164 the electronic content and launch 166 startup content designated by the user. The instructions 104 can also store 166 an indication that the user has received an access grant, for example, by storing the envelope ID or a server supplied key in the Registry.

Alternatively, if the server 112 denied access (e.g., the payment service denied payment authorization or communication with the server 112 failed), the instructions 104 can display a message to the user describing why the electronic content is not being presented.

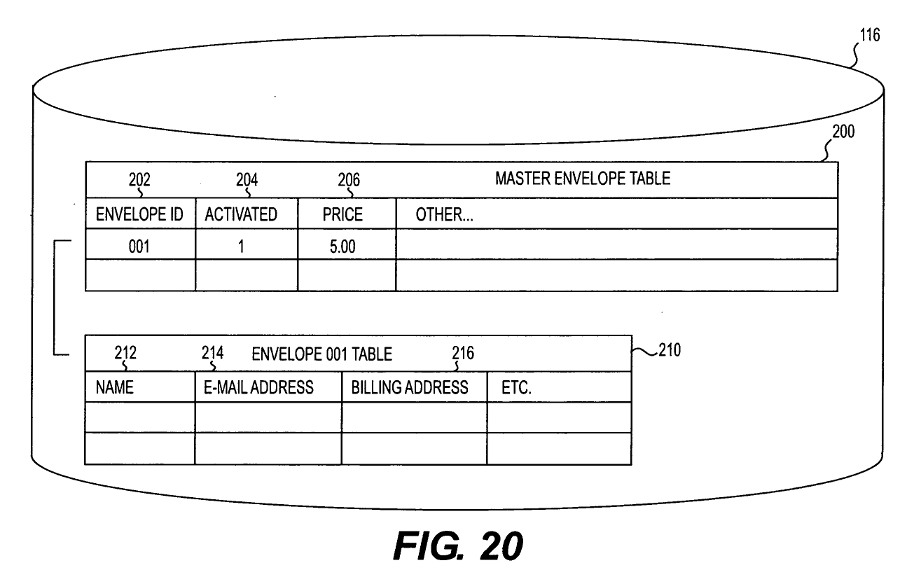

Referring to FIG. 20, the server 112 includes an envelope database 116 that tracks each envelope that has generated an access request. As shown the database 116 includes a master envelope table 200. Each row of the master envelope table 200 stores information for a different envelope. The master envelope table 200 lists each envelope's ID 202, the price of the envelope's contents 206, and can include a boolean “activated” field 204 that indicates whether or not the server is permitted to grant access. For example, a server 112 administrator may request a fee from an envelope creator before setting the activated field 204 for an envelope to TRUE (e.g., “1”). The table may also include an envelope creator's credit card account number (not shown) so that payments may be credited to the creator.

The database 116 also includes a separate envelope description table 210 for each envelope. The columns in the envelope description table 210 include data fields collected by the envelope. The server 112 dynamically creates the envelope description table 210 upon receiving the first access request for an envelope. The dynamic creation of an individualized table 210 for an envelope enables the server to store different creator-defined data for each envelope.

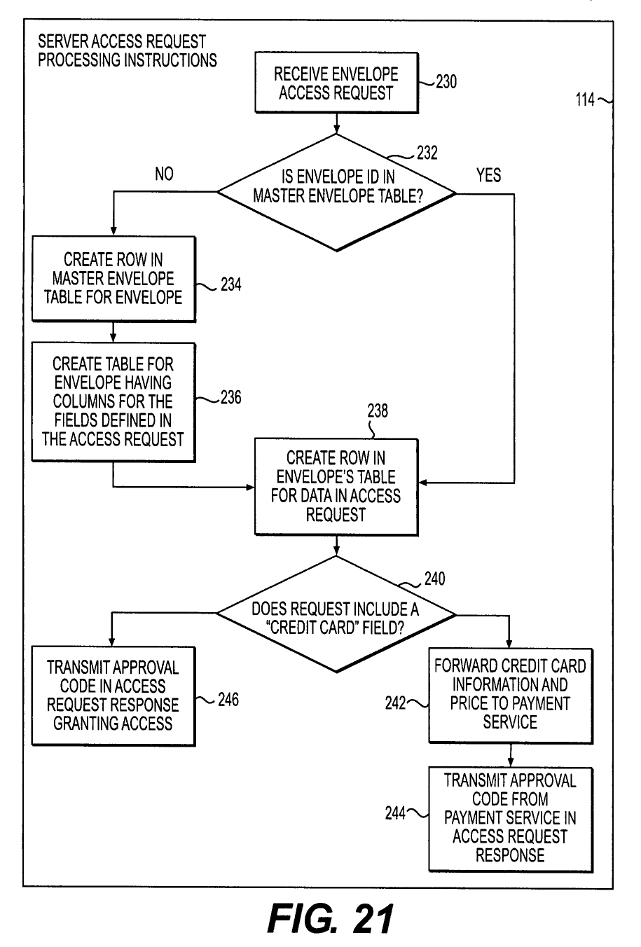

Referring to FIG. 21, the server instructions 114 process a received access request 230 by determining 232 whether the envelope ID included in the access request already is present in the master envelope table. If not, a row is added in the master envelope table 234 and an independent envelope description table is created 236 for the envelope. The collected data included in the access request is added 238 as a row in the envelope description table.

If the collected data does not include a “CC#” or “credit card number” data field 240, the server 112 can transmit an access request response to the client 100 granting access to the electronic content.

If the collected data includes a credit card number field 240, the server 112 transmits 242 a payment authorization request to the payment server and awaits a response. The payment authorization request includes the credit card number and the credit card expiration date. The request may also include the envelope price. Alternatively, the price may be stored in the master envelope table.

If the payment server authorizes payment of the price of the electronic content, the server 112 transmits an access request response to the client 244 indicating that the envelope instructions 114 should grant access. The server instructions 114 may track the success and failure of envelope access requests over time.

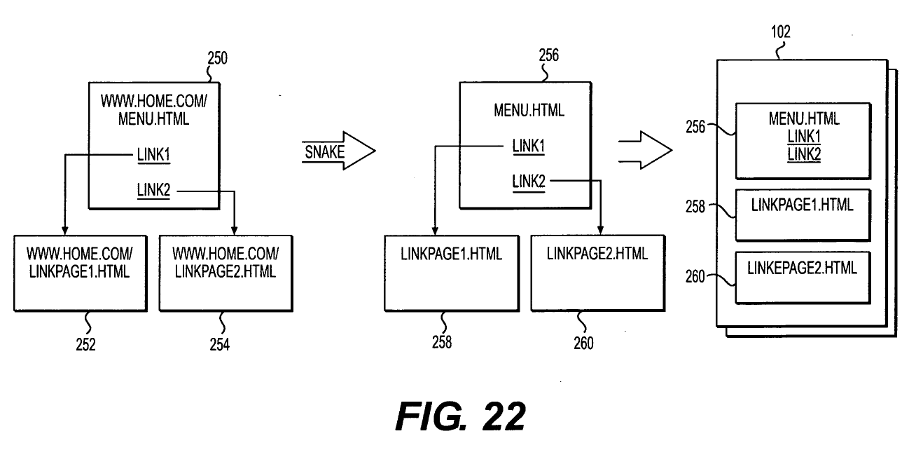

Referring to FIG. 22, one possible use of the system described above is for distributing web-pages provided at a web-site via an envelope. As shown, a top-level web-page 250 includes URL links to other web-pages 252, 254. Although an envelope creator could include the top-level web-page 250 in an envelope without modification, when a user selected a link (e.g., link 1), the client would be forced to establish a network connection and download the corresponding URL (e.g., www.home.com/linkpagel.html). The use of a “snake” (e.g., Blue Squirrel Software's Grab-a-Site) copies and modifies links in a collection of pages to reference local files instead of URLs. For example, after use of a snake, the top-level web-page 256 links to local files linkpage1.html and linkpage2.html instead of their respective URLs. These pages can be included in an envelope 102 and permit a user to browse through the pages without waiting for the pages to download. A creator can designate the top-level page 256 for automatic launching. Thus, when a recipient is granted access, immediately the recipient is presented with a page that guides the recipient in navigating through the electronic content. This feature can be very useful in distributing marketing material such as electronic catalogs.

The techniques described here are not limited to any particular hardware or software configuration; they may find applicability in any computing or processing environment. The techniques may be implemented in hardware or software, or a combination of the two. Preferably, the techniques are implemented in computer programs executing on programmable computers that each include a processor, a storage medium readable by the processor (including volatile and non-volatile memory and/or storage elements), at least one input device, and one or more output devices. Program code is applied to data entered using the input device to perform the functions described and to generate output information. The output information is applied to one or more output devices.

Each program is preferably implemented in a high level procedural or object oriented programming language to communicate with a computer system. however, the programs can be implemented in assembly or machine language, if desired. In any case, the language may be a compiled or interpreted language.

Each such computer program is preferable stored on a storage medium or device (e.g., CD-ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

What is claimed is:

1. A computer-implemented method for controlling access to electronic content, the method comprising the steps of:
maintaining in a computer database information related to one or more electronic envelopes each having an identifier and each having at least one electronic content, the one or more envelopes configured to initiate an access request based on a triggering event, wherein the information includes a price associated with the at least one electronic content;
at the server, determining whether or not authorization has been permitted to grant access to the at least one electronic content upon receipt of the access request; and
if authorization has been permitted, granting access to the at least one electronic content.

2. The computer-implemented method of claim 1, further comprising the step of maintaining payment information for the one or more envelopes so that payments may be credited to an account associated with the one or more envelopes.

3. The computer-implemented method of claim 2, wherein the account is a credit card account.

4. The computer-implemented method of claim 1, wherein the one or more envelopes are configured to be accessed at a client device to cause initiation of the access request.

5. The computer-implemented method of claim 1, wherein the step for determining includes checking whether or not a fee has been paid.

6. The computer-implemented method of claim 1, further comprising the step of dynamically creating one or more database entries each having data fields, wherein the data fields correspond to data collected by executable instructions as part of the one or more envelopes.

7. The computer-implemented method of claim 6, wherein the data fields include at least any one of: an email address, a billing address, a name and a credit card number.

8. The computer-implemented method of claim 6, wherein the step for dynamically creating creates the database entry upon receiving a first access request.

9. The computer-implemented method of claim 6, wherein the step of dynamically creating creates a plurality of entries wherein at least two entries have a least one differing type of field.

10. The computer-implemented method of claim 1, further comprising the step of sending a payment authorization request prior to granting access, and granting access only if authorization is obtained.

11. The computer-implemented method of claim 10, wherein the step for sending the payment authorization includes sending credit card information collected by executable instructions conveyed by the one or more envelopes.

12. The computer-implemented method of claim 1, further comprising the step of charging an account based on the price.

13. The computer-implemented method of claim 12, wherein the account is associated with an accessor of the one or more envelopes.

14. The computer-implemented method of claim 1, wherein the one or more envelopes are associated with a subsequent recipient of the envelopes.

15. The computer-implemented method of claim 14, wherein the subsequent recipient is a recipient who receives a copy of the one or more envelopes by electronic communications from a previous recipient.

16. The computer-implemented method of claim 1, wherein the at least one electronic content includes at least anyone of: an audio file, a graphics file, a video file and a file of computer instructions.

17. A computer program product having instructions embedded in a computer readable medium, the instructions configured to initiate or execute the following steps:
at a server, maintaining in a computer database information related to one or more envelopes each having an identifier and each having at least one electronic content, the one or more envelopes configured to initiate an access request when accessed, wherein the information includes a price associated with the at least one electronic content;
at the server, determining whether or not authorization has been permitted to grant access to the at least one electronic content upon receipt of the access request; and
if authorization has been permitted, granting access to the at least one electronic content.

18. The computer program product of claim 17, wherein the instructions are further configured to initiate or execute the step of maintaining payment information for the one or more envelopes so that payments are credited to an account associated with the one or more envelopes.

19. The computer program product of claim 18, wherein the account is a credit card account.

20. The computer program product of claim 17, wherein the one or more envelopes are configured to be accessed at a client device to cause initiation of the access request.

21. The computer program product of claim 17, wherein the step for determining includes checking whether or not a fee has been paid.

22. The computer program product of claim 17, wherein the instructions are further configured to initiate or execute the step of dynamically creating one or more database entries each having data fields, wherein the data fields correspond to data collected by executable instructions as part of the one or more envelopes.

23. The computer program product of claim 22, wherein the data fields include at least any one of: an email address, a billing address, a name and a credit card number.

24. The computer program product of claim 17, wherein the step for dynamically creating creates the database entry upon receiving a first access request.

25. The computer program product of claim 17, wherein the step of dynamically creating creates a plurality of entries wherein a subset of entries has different types of fields.

26. The computer program product of claim 17, wherein the instructions are further configured to initiate or execute the step of: sending a payment authorization request prior to granting access, and granting access if authorization is obtained.

27. The computer program product of claim 26, wherein the step for the sending payment authorization includes sending credit card information collected by executable instructions conveyed by the one or more envelopes.

28. The computer program product of claim 17, wherein the instructions are further configured to initiate or execute the step of charging an account based on the price.

29. The computer program product of claim 28, wherein the account is associated with an accessor of the one or more envelopes.

30. The computer program product of claim 17, wherein the one or more envelopes are associated with a subsequent recipient of the envelopes.

31. The computer program product of claim 30, wherein the subsequent recipient is a recipient who receives a copy of the one or more envelopes by electronic communications from a previous recipient.

32. The computer program product of claim 17, wherein the at least one electronic content includes at least anyone of: an audio file, a graphics file, a video file and a file of computer instructions.

33. A system for controlling access to electronic content, comprising:
means for maintaining in a computer database information related to one or more envelopes each having an identifier and each having at least one electronic content, the one or more envelopes configured to initiate an access request when accessed, wherein the information includes indicia associated with the at least one electronic content;
means for determining whether or not authorization has been permitted to grant access to the at least one electronic content upon receipt of the access request; and
means for granting access to the at least one electronic content based on whether or not authorization has been permitted.

34. The system of claim 33, wherein the one or more envelopes are associated with a subsequent recipient of the envelopes and the means for granting access grants access to the subsequent recipient, wherein the subsequent recipient includes a recipient who receives a copy of the one or more envelopes by electronic communications from a previous recipient.

35. The system of claim 33, wherein the at least one electronic content includes at least any one of: an audio file, a graphics file, a video file and a file of computer instructions.

36. The system of claim 33, further comprising means for maintaining payment information for the one or more envelopes so that payments may be credited to an account associated with the one or more envelopes.

37. The system of claim 36, wherein the account is a credit card account.

38. The system of claim 33, wherein the one or more envelopes are configured to be accessed at a client device to initiate the access request.

39. The system of claim 33, wherein the means for determining includes means for checking whether or not a fee has been paid.

40. The system of claim 33, further comprising means for dynamically creating one or more database entries each having data fields, wherein the data fields correspond to data collected by executable instructions as part of the one or more envelopes.

41. The system of claim 40, wherein the data fields include at least any one of: an email address, a billing address, a name and a credit card number.

42. A computer-implemented method of controlling access to electronic content, the computer-implemented method comprising the steps of:
modifying at least one uniform resource locator (URL) link in a web page to reference at least one local file representative of web page information identified by the URL link;
including the modified web page and the at least one local file as electronic content in an electronic envelope, wherein the modified web page permits navigation to the at least one local file;
transmitting the envelope containing the electronic content to a device; and
wherein the electronic envelope is configured to present, upon an attempt to access the envelope, at least a portion of the electronic content, and wherein the modified web page permits navigation to the at least one local file at the device.

43. The computer-implemented method of claim 42, further comprising the step of granting access to at least a portion of the electronic content prior to presenting the at least a portion of the electronic content.

44. The computer-implemented method of claim 42, wherein the envelope is configured to grant access to at least a portion of the electronic content based upon a communication other than the step for transmitting.

45. The computer-implemented method of claim 42, wherein the envelope is configured to grant access to at least a portion of the electronic content based upon a result of an attempt to send notification information.

46. The computer-implemented method of claim 42, wherein the electronic content comprises marketing material.

47. The computer-implemented method of claim 42, wherein the electronic content includes at least any one of: an audio file, a graphics file, a video file and a file of computer instructions.
